(19) United States
(12) Patent Application Publication
(10) Pub. No.: US 2019/0273540 A1
(43) Pub. Date: Sep. 5, 2019

(54) Device and Method for Communicating With At Least One Neighboring Device

(71) Applicants: Koninklijke KPN N.V., Rotterdam (NL); Nederlandse Organisatie voor Toegepast- Natuurwetenschappelijk Onderzoek TNO, 's-Gravenhage (NL)

(72) Inventors: Harm Cronie, Echallens (CH); Matthew Lawrenson, Bussigny (CH); Julian Nolan, Pully (CH); Antonius Norp, The Hague (NL)

(73) Assignees: Koninklijke KPN N.V., Rotterdam (NL); Nederlandse Organisatie voor Toegepast- Natuurwetenschappelijk Onderzoek TNO, 's-Gravenhage (NL)

(21) Appl. No.: 16/063,504

(22) PCT Filed: Dec. 19, 2016
(86) PCT No.: PCT/EP2016/081740

§ 371 Date: Jun. 18, 2018

(30) Foreign Application Priority Data
Dec. 21, 2015 (EP) 15201470.0

(51) Int. Cl. H04B 7/06; H04W 4/02; H04W 4/46; H04W 4/70; H04W 16/28

(52) U.S. Cl. CPC H04B 7/0617; H04W 4/023; H04W 16/28; H04W 4/70; H04W 4/46

(57) ABSTRACT

The invention relates to a device (1) for communicating with one or more neighboring devices (11). The device (1) comprises a transmitter (3) for transmitting a data signal to one or more neighboring devices (11) and/or a receiver (5) for receiving a data signal from one or more neighboring devices (11). The device (1) further comprises a processor (7). The processor (7) is configured to determine a distance and/or a direction to one or more neighboring devices relative to the device (1). This distance and/or direction are determined using at least one sensor (9) other than the receiver (5). The processor (7) is further configured to configure the transmitter (3) and/or the receiver (5) in dependence on the determined distance and/or direction. The processor (7) is also configured to use the transmitter (3) to transmit a data signal to at least one of the one or more neighboring devices (11) and/or to use the receiver (5) to receive a data signal from at least one of the one or more neighboring devices (11). The invention further relates to the method performed by the device and a computer program product enabling a computer system to perform this method.

### FIELD OF THE INVENTION

The invention relates to a device for communicating with at least one neighboring device, and relates to a vehicle comprising such a device.

The invention further relates to a method of communicating with at least one neighboring device.

The invention also relates to a computer program product enabling a computer system to perform such a method.

### BACKGROUND OF THE INVENTION

US2010/0214085 discloses a method and system for using vehicle-to-vehicle cooperative communications for traffic collision avoidance. One device detects a “situation”, such as a pedestrian within the crosswalk, where an “offending object” is in or near a roadway feature, which could result in a collision. The detecting vehicle informs a second vehicle via wireless communication of the detecting vehicle's geographic location, the geographic location of the detected object, and the geographic location of the roadway feature, e.g. a crosswalk boundary. A receiving vehicle receives this data and takes appropriate avoidance action.

A drawback of this device and method is that in more complex situations, interference between devices becomes an issue. For example, a vehicular network may be very dense and very dynamic in nature. Vehicles may be constantly moving and a large number of vehicles may be present in a relatively small area. Furthermore, large amounts of data may be exchanged between individual vehicles and vehicles and base stations.

### SUMMARY OF THE INVENTION

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the users computer, partly on the users computer, as a stand-alone software package, partly on the users computer and partly on a remote computer, or entirely on the remote computer or server. In the latter scenario, the remote computer may be connected to the users computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is a first object of the invention to provide a device for communicating with at least one neighboring device, which reduces interference in inter-device communication.

It is a second object of the invention to provide a method of communicating with at least one neighboring device, which reduces interference in inter-device communication.

According to the invention, the first object is realized in that the device comprises at least one of a transmitter for transmitting a data signal to at least one neighboring device and a receiver for receiving a data signal from at least one neighboring device, and a processor configured to determine at least one of a distance and a direction to at least one neighboring device relative to said device, said at least one of said distance and said direction being determined using at least one sensor other than said receiver, to configure at least one of said at least one of said transmitter and said receiver in dependence on said at least one of said distance and said direction, and to use said at least one of said transmitter and said receiver, said transmitter being used to transmit a data signal to at least one of said at least one neighboring device and said receiver being used to receive a data signal from at least one of said at least one neighboring device on said device. When a component, e.g. an antenna array, used by the transmitter and/or the receiver is configured, this is considered to configure the transmitter and/or the receiver itself.

The device may be moving, for example. A neighboring device is typically a device within sensor range of the at least one sensor, e.g. within line of sight. Preferably, at least one of the at least one neighboring device is a moving device. In an embodiment, all of the at least one neighboring device are moving devices. Said at least one of said distance and said direction may be determined using further components in addition to said at least one sensor, for example. When the at least one neighboring device comprises multiple neighboring devices, multiple pairs of distance/direction may be determined and used to configure the at least one transmitter and/or the at least one receiver, for example, to form multiple beamforming bundles.

The inventors have recognized that configuring the transmitter and/or receiver based on the determined distance and/or direction, e.g. by using beamforming, reduces interference in inter-device communication. The inventors have further recognized that beamforming can benefit from using at least one sensor other than the receiver to determine the distance and/or direction. Using geographic coordinates obtained from positioning systems like GPS and received from neighboring devices instead of using such a sensor or such sensors may not work adequately, because the granularity of geographic coordinates is too coarse in situations where devices are in relative proximity, amongst others.

Furthermore, it is not necessarily straightforward to get the GPS coordinates of, for example, a vehicle in front of the device. First, the device may have to identify the vehicle, communicate with it, and then get its position. While communicating, interference is already caused. Furthermore, the roundtrip delay may be too large and this approach may not scale well.

Using conventional antenna array training techniques, e.g. based on direction of arrival techniques, may not work well either, because these training algorithms require feedback and several iterations to converge to a set of stable antenna array coefficients. This may become increasingly difficult when at least one of the device and the neighboring device is moving with respect to the other. For example, if a neighboring device comes in proximity of the device, the device may need to communicate with this neighboring device, and if the receiver has to be used to determine whether an additional beamforming bundle has to be configured for communication with this neighboring device, instead of using the invention, the receiver has to implement a scanning/broadcasting mode to acquire new devices in addition to the beamforming mode for communication. The use of such a scanning/broadcasting mode may reduce the advantage beamforming has to minimize interference (interference caused by the device and interference received by the device).

Said processor may be configured to determine a distance to at least one neighboring device relative to said device and to configure said transmitter to adapt its power, preferably only the transmission power in the direction of the neighboring device, in dependence on said distance to said at least one neighboring device relative to said device. If the distance to the at least one neighboring device is known, the power can be less than the maximum (e.g. than the maximum allowed due to legal requirements or the maximum possible with the used hardware) in order to reduce interference experienced by other devices.

Said processor may be configured to determine a direction to at least one neighboring device relative to said device and to configure said at least one of said transmitter and said receiver to adapt its directivity in dependence on said direction to said at least one neighboring device relative to said device. By adapting the directivity of the transmitter, transmissions of the transmitter can be directed only to the neighboring devices to which the device wants to transmit, thereby reducing interference experienced by other devices. By adapting the directivity of the receiver, the receiver can better distinguish signals from relevant neighboring devices from signals from other devices, thereby reducing interference caused by these other devices.

Said device may comprise said at least one sensor. Although it is possible to use at least one sensor that is not part of the device, e.g. one or more sensors of one or more base stations could determine the distance and/or direction to the at least one neighboring device, this would require the distance and/or direction data to be converted from data relative to the position of the (base station) sensor to data relative to the position of the device.

Said at least one sensor may use at least one of LIDAR, radar, sonar, image recognition, structured light and 3D vision to determine said at least one of said distance and said direction to said at least one neighboring device relative to said device. These techniques can all be used to determine distances and directions to neighboring devices without relying on data transmitted by these neighboring devices and are therefore suited to complex situations, e.g. a very dense and dynamic vehicular network. Said at least one sensor may additionally or alternatively use other technologies. Different technologies and/or sensors may be used to determine distance and direction, for example. The processor may be able to combine multiple sensor input to determine the distance and direction to the at least one neighboring device relative to the device, for example.

Said processor may be configured to determine both a distance and a direction to said at least one neighboring device relative to said device. In this case, said processor may be further configured to determine a depth map from said distance and said direction to said at least one neighboring device relative to said device. A device that determines both distance and direction to the at least one neighboring device relative to the device, and configures the transmitter and/or receiver accordingly, reduces interference more than a device that only determines the distance to neighboring devices or only determines the direction to neighboring devices. The advantage of determining a depth map is that depth maps have been standardized and are being standardized and existing methods and tools for creating and working with depth maps can be re-used.

Said processor may be further configured to determine at least one of a movement speed and a movement direction of said at least one neighboring device relative to said device and to configure said at least one of said transmitter and said receiver in dependence on said at least one of said movement speed and said movement direction. Directivity and power of the transmitter and directivity of the receiver can be configured more optimally for moving neighboring devices when the movement speed and/or movement direction of these neighboring devices is known. For example, transmitter power can be reduced when a neighboring device (or the farthest neighboring device if the transmit power cannot be set per neighboring device) is moving towards the device and may have to be increased when the (farthest) neighboring device moves away from the device until a maximum transmitter power threshold may be reached. Here the farthest neighboring device is the neighboring device farthest away that is still relevant for transmission from/to the device, e.g. within a certain neighborhood area that may vary with the movement direction and/or movement speed of the device.

Said at least one of said transmitter and said receiver may be coupled to an array of antennas. This allows beamforming to be used to adapt the directivity of the transmitter and/or receiver and/or the transmit power of the transmitter. If the transmitter is used to transmit to multiple neighboring devices, it may be possible to set one beamforming bundle at a low power for a nearby device and to set another beamforming bundle at a high power for a (relatively) faraway device, for example.

Said processor may be further configured to determine a weather condition and to configure said at least one of said transmitter and said receiver in dependence on said weather condition. Weather conditions can have a non-negligible impact on RF communications. For instance, in the 60 GHz band, the propagation conditions become worse when fog is present. Additional transmission power may be used for the main lobe of the antenna pattern when fog is present. It may be possible to use the at least one sensor to determine the weather condition, e.g. if it is a LIDAR sensor.

According to the invention, the second object is realized in that the method comprises the steps of determining at least one of a distance and a direction to at least one neighboring device relative to a device, said at least one of said distance and said direction being determined using at least one sensor other than a receiver used by said device to receive a data signal from said at least one neighboring device, configuring at least one of a transmitter and said receiver in dependence on said at least one of said distance and said direction, and using said at least one of said transmitter and receiver, said transmitter being used to transmit a data signal from said device to at least one of said at least one neighboring device and said receiver being used to receive a data signal from at least one of said at least one neighboring device on said device. Said method may be performed by software running on a programmable device. This software may be provided as a computer program product.

Said at least one sensor may use at least one of LIDAR, radar, sonar, image recognition, structured light and 3D vision to determine said at least one of said distance and said direction to said at least one neighboring device relative to said device.

The step of determining at least one of a distance and a direction to at least one neighboring device relative to a device may comprise determining said distance and said direction to said at least one neighboring device relative to said device.

The step of determining at least one of a distance and a direction to at least one neighboring device relative to a device may comprise determining a depth map from said distance and said direction to said at least one neighboring device relative to said device.

The step of determining at least one of a distance and a direction may comprise determining a distance to said at least one neighboring device relative to said device and the step of configuring at least one of a transmitter and said receiver may comprise configuring said transmitter to adapt its power in dependence on said distance to said at least one neighboring device relative to said device.

The step of determining at least one of a distance and a direction may comprise determining a direction to at least one neighboring device relative to said device and the step of configuring at least one of a transmitter and said receiver may comprise configuring said at least one of said transmitter and said receiver to adapt its directivity in dependence on said direction to said at least one neighboring device relative to said device.

The method may further comprise the step of determining at least one of a movement speed and a movement direction of said at least one neighboring device relative to said device and the step of configuring at least one of a transmitter and said receiver in dependence on said at least one of said distance and said direction may further comprise configuring said at least one of said transmitter and said receiver in dependence on said at least one of said movement speed and said movement direction.

The method may further comprise the step of determining a weather condition and the step of configuring at least one of a transmitter and said receiver in dependence on said at least one of said distance and said direction may further comprise configuring said at least one of said transmitter and said receiver in dependence on said weather condition.

In another aspect of the invention, a device for communicating with at least one neighboring device comprises at least one of a transmitter for transmitting a data signal to at least one neighboring device and a receiver for receiving a data signal from at least one neighboring device, and a processor configured to determine at least one of a distance and a direction to at least one neighboring device relative to said device, said at least one of said distance and said direction being determined using at least one sensor, said at least one sensor sensing electromagnetic signals in a different frequency band than a frequency band used by said receiver to receive said data signal from said at least one neighboring device, to configure at least one of said at least one of said transmitter and said receiver in dependence on said at least one of said distance and said direction, and to use said at least one of said transmitter and said receiver, said transmitter being used to transmit a data signal to at least one of said at least one neighboring device and said receiver being used to receive a data signal from at least one of said at least one neighboring device on said device

In a further aspect of the invention, a method of communicating with at least one neighboring device comprises the steps of determining at least one of a distance and a direction to at least one neighboring device relative to a device, said at least one of said distance and said direction being determined using at least one sensor, said at least one sensor sensing electromagnetic signals in a different frequency band than a frequency band used by said device to receive a data signal from said at least one neighboring device, configuring at least one of a transmitter and said receiver in dependence on said at least one of said distance and said direction, and using said at least one of said transmitter and receiver, said transmitter being used to transmit a data signal from said device to at least one of said at least one neighboring device and said receiver being used to receive a data signal from at least one of said at least one neighboring device on said device.

Moreover, a computer program for carrying out the method described herein, as well as a non-transitory computer readable storage-medium storing the computer program are provided. A computer program may, for example, be downloaded by or uploaded to an existing device or be stored upon manufacturing of these devices or systems.

A non-transitory computer-readable storage medium stores at least one software code portion, the software code portion, when executed or processed by a computer, being configured to perform executable operations comprising: determining at least one of a distance and a direction to at least one neighboring device relative to a device, said at least one of said distance and said direction being determined using at least one sensor other than a receiver used by said device to receive a data signal from said at least one neighboring device, configuring at least one of a transmitter and said receiver in dependence on said at least one of said distance and said direction, and using said at least one of said transmitter and receiver, said transmitter being used to transmit a data signal from said device to at least one of said at least one neighboring device and said receiver being used to receive a data signal from at least one of said at least one neighboring device on said device.

### BRIEF DESCRIPTION OF THE DRAWINGS

These and other aspects of the invention are apparent from and will be further elucidated, by way of example, with reference to the drawings, in which:

FIG. 1 is a block diagram of the device of the invention;

FIG. 2 is a block diagram of an embodiment of the device;

FIG. 3 is a block diagram of an array of antennas used in an embodiment of the device;

FIG. 4 illustrates an embodiment of the device determining distance and/or direction to neighboring devices;

FIG. 5 illustrates an embodiment of the device transmitting from and/or receiving to neighboring devices;

FIG. 6 is a flow diagram of the method of the invention;

FIG. 7 is a block diagram of an array of antennas used in a second embodiment of the device;

FIG. 8 is an example of an antenna pattern used by the device in an embodiment; and

FIG. 9 is a block diagram of an exemplary data processing system for performing the method of the invention.

Corresponding elements in the drawings are denoted by the same reference numeral.

### DETAILED DESCRIPTION OF THE DRAWINGS

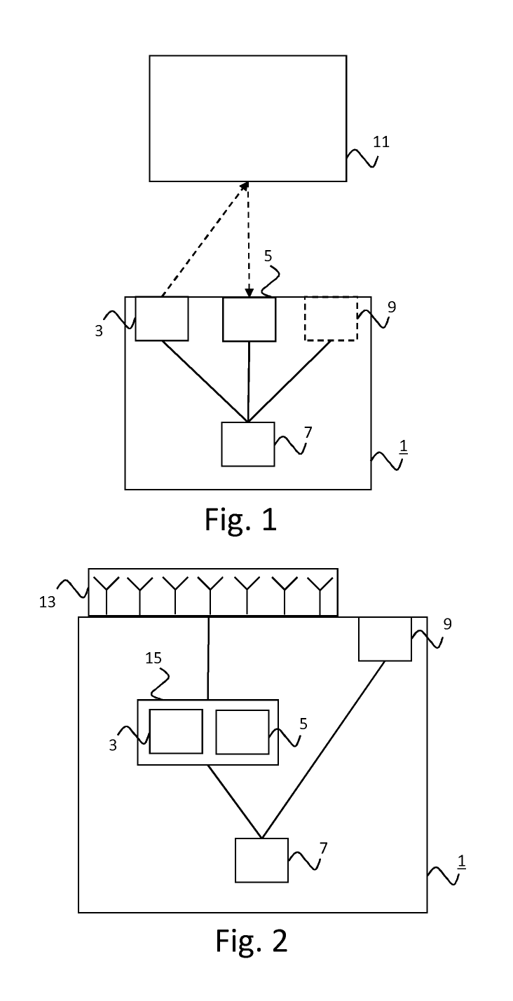

The device 1 of the invention comprises a transmitter 3 for transmitting a data signal to at least one neighboring device 11 and/or a receiver 5 for receiving a data signal from at least one neighboring device 11, see FIG. 1. The device 1 further comprises a processor 7. The processor 7 is configured to determine a distance and/or a direction to at least one neighboring device 11 relative to the device 1. The distance and/or the direction are determined using at least one sensor 9 other than the receiver 5. The processor 7 is further configured to configure the transmitter 3 and/or the receiver 5 in dependence on the distance and/or the direction. The processor 7 is also configured to use the transmitter 3 to transmit a data signal to at least one of the at least one neighboring device 11 and/or to use the receiver 5 to receive a data signal from at least one of the at least one neighboring device 11. One, multiple or all of the at least neighboring device 11 may be moving. The device 1 may be only receiving a data signal, e.g. when it is part of a road infrastructure, or the device 1 may be only transmitting a data signal, e.g. when the device 1 is an emergency car sending information forward in its driving lane requesting vehicles in that lane to get out of the way or road infrastructure informing vehicles of a speed limit or speed advice. If the device 1 is a regular car, it is preferably both receiving a data signal and transmitting a data signal. When the device 1 is part of a road infrastructure, the device 1 can be employed to determine congestion (or other events) on the road by listening to information sent out by the cars travelling on that road and/or to send data (e.g. advice of maximum speed and best speed to get through traffic lights) to cars travelling on that road, for example.

In an embodiment, the device 1 comprises the at least one sensor 9 as shown in FIG. 1. The device 1 may be a vehicle or a module to be incorporated in a vehicle, for example. The neighboring device 11 may be another vehicle, for example. The at least one sensor 9 may be an existing sensor that is re-used, e.g. at least one sensor used by self-driving vehicles to detect objects. The at least one sensor 9 could alternatively be part of a base station, for example, e.g. if the device 1 is a vehicle. The device 1 may itself be a base station instead of a vehicle, for example. This base station may disseminate a real-time 3D map of the environment to vehicles traveling on a road. Such a 3D map may then be used by vehicles to acquire situational awareness.

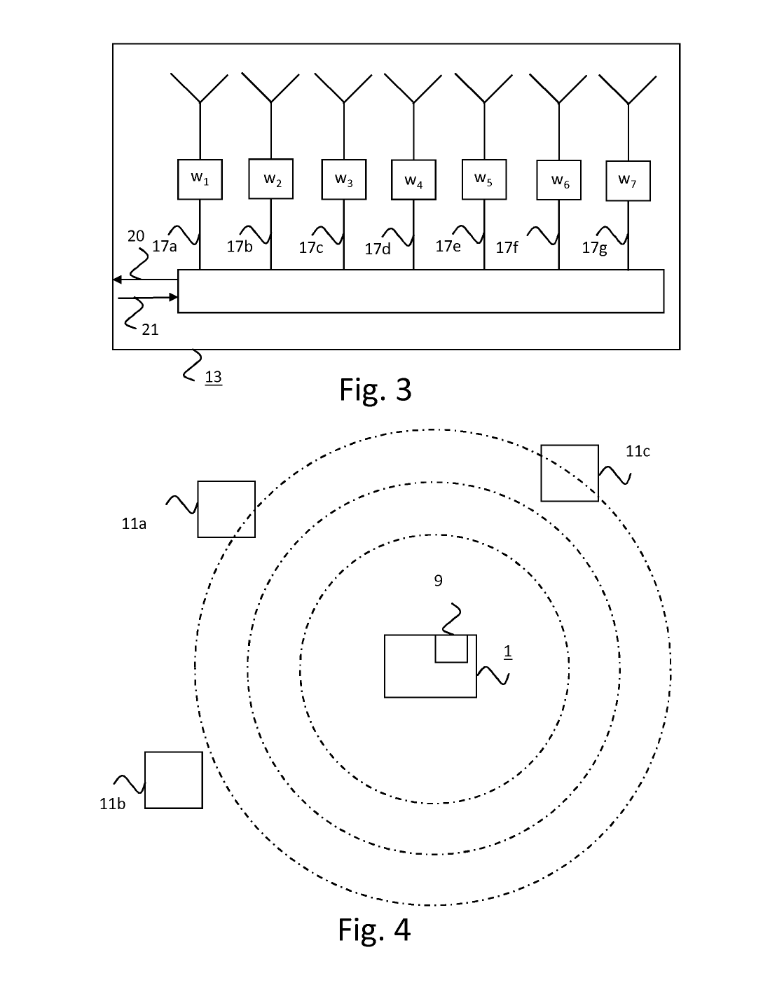

In the embodiment of the device 1 shown in FIG. 2, transmitter 3 and receiver 5 are coupled to an array of antennas 13. In this embodiment, the transmitter 3 and the receiver 5 are part of a transceiver 15 and the at least one sensor 9 is part of the device 1. In the embodiment shown in FIG. 3, the array of antennas 13 comprises seven antennas 17a-g. The antennas 17a-g of the antenna array 13 may be arranged in a linear configuration, a rectangular configuration, or a circular configuration, for example. Alternatively, the antenna array elements 17a-g may be arranged in a three-dimensional configuration, for example.

The processor 7 is configured to configure the individual antennas 17a-g of antenna array 13 for transmission and/or reception, e.g. by setting the amplitude and phase of the signals for each of the elements 17a-g of the antenna array 13. In this embodiment, the antenna array 13 can be used for both transmission and reception of data signals, e.g. to a neighboring device 11 in the vicinity of the device 1. In another embodiment, the device 1 may only be able to transmit data signals, may only be able to receive data signals or may use different antennas/antenna arrays for transmitting and receiving. The spacing between the antenna array elements 17a-g may be in the order of the wavelength of the electromagnetic waves used for communication, for example. Although the embodiment of the antenna array 13 shown in FIG. 3 comprises seven antennas 17a-g, the antenna array 13 could alternatively comprise more or fewer antennas.

The input signal of the antenna array 13, provided by transmitter 3, is denoted by input signal 21. The input signal 21 is processed by an array coefficient for each of the 7 array elements. The array coefficients can be denoted by w₁, . . . , w_{N} (N being the number of antennas, N being 7 in this embodiment). To define the operation of the antenna array 13, a complex sinusoidal may be taken for input signal 21. The reason is that the main operation of the antenna array is linear, and any input signal may be decomposed into a sum of complex sinusoidal signals by, for instance, the Fourier transform. The wireless output of the antenna array 13 is then equal to a superposition of the response of the antenna array 13 to the constituent sinusoidal signals of the input signal 21. For a complex sinusoidal input, the wireless output of the ith element of the antenna array may be written as sᵢ(t)=wᵢ(f)e^{j(sqrt(-1))2πft}, where wₜ(t) is a complex number that denotes the array coefficient for the ith antenna. The input signal 21 is thus multiplied by the array coefficients to obtain the wireless output. wᵢ is in general a function of the frequency.

The output signal of the antenna array, provided to receiver 5, is denoted by output signal 20. As before, the operation of the array may be defined in terms of a complex sinusoidal signal. The wireless signal received at the ith antenna may be written as yᵢ(t)=Rᵢe^{jφ(i)}e^{j2πft}. Here Rᵢ is a complex number that denotes the received amplitude and φ(i) an additional phase shift which depends on the spatial location of the antenna element. Each of these signals may be multiplied by the array coefficients, and the results summed to generate the output signal 20.

Alternatively, other beamforming architectures may be used. A well-known architecture is the sum-and-delay beamforming architecture. The array coefficients that multiply the complex sinusoid signals effectively implement a phase shift of these sinusoidal signals. In case the transmitted or received signal is narrow-band, the phase shift may be replaced by a time delay, which leads to the sum-and-delay architecture. The choice of the array coefficients determines the antenna pattern that is generated. Many methods exist to choose these coefficients. Furthermore, several constraints may be taken into account when designing the array coefficients. An overview of several methods is given in “Beamforming: A Versatile Approach to Spatial Filtering”, B. D. Van Veen et al, IEEE ASSP Magazine, April 1988.

In an embodiment of the device 1, the at least one sensor 9 uses at least one of LIDAR, radar, sonar, image recognition, structured light and 3D vision to determine the at least one of the distance and the direction to the at least one neighboring device 11 relative to the device 1. An example of the device 1 determining the distance and/or direction of neighboring devices 11a, 11b and 11c relative the device 1 is illustrated with the help of FIG. 4. FIG. 4 shows a two dimensional map with the device 1 and the neighboring devices 11a-c. One, multiple or all of the neighboring devices 11a-c may be moving. Device 1 may be moving. Alternatively, the at least one sensor 9 is used to acquire a point cloud or depth map, e.g. using time-of-flight techniques if the at least one sensor 9 uses LIDAR. A depth map is for example an image in which the color and/or intensity of the pixels do not represent the color and/or intensity of the object captured in the image, but the distance to this object. This depth map may comprise multiple parts, each for a certain direction, or may be a 360 degrees panoramic map of the environment of the at least one sensor 9, for example. This depth map thus comprises distances and directions to the neighboring devices.

LIDAR is a technology that can be used advantageously to measure the distance and the direction to neighboring devices. It measures distance by illuminating a target with a laser and analyzing the reflected light. For an illuminated point, the time of flight is measured from which the distance from the point to the LIDAR sensor may be derived. By repeating this multiple times for multiple directions (in parallel and/or in sequence), multiple neighboring devices can be detected. By associating each measured distance with the corresponding direction in which the laser was targeted, a depth map or point cloud can be formed. Sonar and radar are technologies similar to LIDAR, but use sound and radio (or micro) waves, respectively, instead of laser. For example, active sonar emits pulses of sound and listens for echoes. These pulses of sound may be in ultrasonic frequencies, for example.

Structured Light involves projecting a known pattern, e.g. a grid, in a certain direction and determining the depth and surface information of the objects in this direction by analyzing the deformation of the known pattern when striking surfaces, e.g. by using a camera. 3D Vision involves using one or more cameras to capture the same scene from different angles and comparing the captured images in order to determine the depth of the objects in the scene. A stereo camera may be used, for example. Multiple stereo cameras may be used to detect neighboring devices 360 degrees around the device, for example. A single camera, e.g. an ordinary camera without 3D, with image recognition may be used to find the direction of objects, for example. Many cars already have cameras, e.g. to detect traffic signs. These cameras may not be able to find distance, but cars may be able to use sensor fusion to build a map of their surroundings using multiple sensors. The receiver 5, e.g. using an antenna area 13, may provide input (for direction) in this sensor fusion.

From the data measured by the at least one sensor 9, the processor 7 identifies other devices of interest in the near environment of the device 1. A device of interest may be a neighboring device that is able to communicate with the device 1. There are several ways neighboring devices may be detected from the sensor data. In some cases the type of device is known (e.g. a vehicle). In such a case image processing techniques may be used to detect these neighboring devices. Furthermore, the actual antenna array may also be detected on the neighboring devices. Another option is to mark devices with a code to make them more recognizable.

In the same or in a different embodiment, the processor 7 is further configured to determine a movement speed and/or a movement direction of the at least one neighboring device 11 relative to the device 1 and to configure the transmitter 3 and/or the receiver 5 in dependence on the movement speed and/or the movement direction. The speed and direction of movement of the neighboring device 11a-c may be determinable from the sensor data. Alternatively, neighboring devices may transmit, e.g. broadcast, data packets comprising this information.

In an embodiment of the device 1, when the processor 7 is configured to determine a direction to at least one neighboring device 11 relative to the device 1, the processor 7 is further configured to configure the at least one of the transmitter 3 and the receiver 5 to adapt its directivity in dependence on the direction to the at least one neighboring device 11 relative to the device 1. For example, an antenna array 13 is configured based on the devices identified from the depth map as measured by a, e.g. LIDAR, sensor 9. This allows the antenna array 13 to create selective antenna patterns that only transmit to and/or receive from the identified devices.

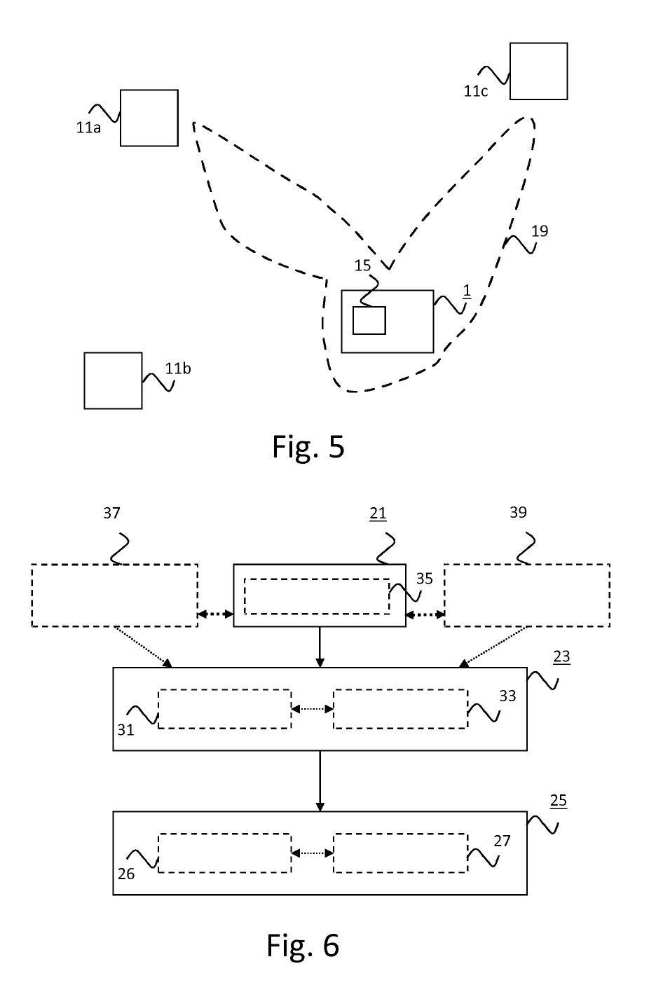

FIG. 5 shows device 1 and its transceiver 15. Transceiver 15 comprises the transmitter 3 and the receiver 5 and is coupled to antenna array 13, as shown in FIG. 2. FIG. 5 further shows the three neighboring devices 11a, 11b and 11c of FIG. 4. One, multiple or all of the neighboring devices 11a-c may be moving. In the example shown in FIG. 5, device 1 decides to transmit and/or receive information only from neighboring devices 11a and 11c and suppress any information sent and/or received from neighboring device 11b, e.g. because neighboring device 11b is moving away in opposite direction from device 1. The antenna pattern 19 can thus be tailored very precisely to devices present in the environment of the device 1. Furthermore, when any of the devices are moving, it is possible to adjust the antenna pattern 19 very rapidly.

When the receiver 5 is configured in dependence on the direction to the neighboring devices 11a-c, the coefficients of the antenna array 13 may be chosen to lead to a maximum transfer function for the neighboring devices 11a and 11c, from which the device 1 would like to receive information, and to lead to a minimum transfer function for possible interfering neighboring device 11b. When the transmitter 3 is configured in dependence on the direction to the neighboring devices 11a-c, the coefficients of the antenna array 13 may be chosen to lead to a maximum transfer function for the neighboring devices 11a and 11c, to which the device 1 would like to transmit information, and to lead to a minimum transfer function for neighboring device 11b, which might experience interference otherwise.

When the processor 7 is configured to determine the distance to the neighboring devices 11a-c, the transmission power corresponding to each of the directions of the antenna pattern 19 may be chosen based on the distance from the device 1 to the neighboring devices present in that particular direction. In this way, only as much transmission power as is required to reach these devices is used. This may lower interference caused to other neighboring devices and decrease spectrum pollution.

The array coefficients may be computed directly, e.g. (near) real-time, as soon as the neighboring devices have been identified, for example. Alternatively, the device 1 may maintain a database of pre-computed antenna patterns, for example. Once the devices are detected from the at least one sensor data, a suitable antenna pattern may be selected from the database.

In the same or in a different embodiment, the processor 7 is further configured to determine a weather condition and to configure the transmitter 3 and/or the receiver 5 in dependence on the weather condition. The weather condition may be extracted from LIDAR data, for example. An example is the presence of fog, which may interfere with RF communications. It is well known that in the 60 GHz band, the propagation conditions become worse when fog is present. The processor 7 may set the antenna array coefficients and transmission power based on the weather condition. When fog is present additional transmission power may be used for the main lobe of the antenna pattern. Furthermore, the side lobes will be additionally attenuated by the fog, which causes less interference.

The method of the invention comprises at least three steps, see FIG. 6. A step 21 comprises determining a distance and/or a direction to at least one neighboring device relative to a device, the distance and/or the direction being determined using at least one sensor other than a receiver used by the device to receive a data signal from the at least one neighboring device. A step 23 comprises configuring a transmitter and/or the receiver in dependence on the distance and/or the direction. A step 25 comprises a step 26 of using the transmitter to transmit a data signal from the device to at least one of the at least one neighboring device and/or a step 27 of using the receiver to receive a data signal from at least one of the at least one neighboring device on the device. The at least one sensor used in step 21 may use at least one of LIDAR, radar, sonar, image recognition, structured light and 3D vision to determine the at least one of the distance and the direction to the at least one neighboring device relative to the device.

In an embodiment of the method, step 21 comprises a step 35 of acquiring a depth map using the, e.g. LIDAR, sensor data. The acquired depth map is used to identify devices in the near environment of the (main) device. These are devices that are in the line-of-sight of the device, and that may receive communications from the device. Preferably, only those devices are selected from which it is desirable to receive information.

In this embodiment, step 23 may comprise a step 31 of configuring the transmitter (e.g. by configuring the antenna array it uses) to selectively transmit into directions that correspond to a subset or all of the devices identified in the depth map and/or configuring the receiver (e.g. by configuring the antenna array it uses) to selectively receive from a subset or all of the devices identified in the depth map. The transmitter may be configured such that the transmission power is very low (e.g. a null) for directions corresponding to devices that are not in the (sub)set of identified devices. Furthermore, the distance from the device to each of the neighboring devices may also be taken into account. This may be achieved by e.g. choosing the transmission power for each direction based on the distance in step 33. Steps 31 and 33 may be performed in parallel or one after the other in any desired order.

If the transmitter is configured according to step 23, the transmitter transmits data to the identified devices in step 25 with the antenna pattern configured in step 23. Otherwise, the transmitter transmits data using its default or differently configured antenna pattern 19. In the embodiment shown in FIG. 5, the same antenna pattern is used to transmit data to each of the identified devices. In an alternative embodiment, a first antenna pattern is used to transmit data to a first subset of the identified devices and a second pattern is used to transmit data to a second subset of the identified devices. A different antenna pattern may even be used for each different detected device to which the (main) device transmits data.

If the receiver is configured according to step 23, the receiver receives data in step 27 with the antenna pattern 19 configured in step 23. Otherwise, the receiver receives data using its default or differently configured antenna pattern. In the embodiment shown in FIG. 5, the same antenna pattern is used to receive data from each of the identified devices. In an alternative embodiment, a first antenna pattern is used to receive data from a first subset of the identified devices and a second pattern is used to receive data from a second subset of the identified devices. A different antenna pattern may even be used for each different detected device from which the (main) device receives data. This is beneficial e.g. when the identified devices use time division multiple access or frequency division multiple access and the device 1 knows which time slot or frequency an identified device uses. The device 1 may switch between using a dedicated antenna pattern for identified devices of which this information is known and an omni-directional pattern for the other identified devices, for example.

In the same or in a different embodiment, the method further comprises a step 37 of determining a movement speed and/or a movement direction of the at least one neighboring device, e.g. neighboring devices 11a and 11c of FIG. 5, relative to the device, and step 23 further comprises configuring the transmitter and/or the receiver in dependence on this movement speed and/or this movement direction.

In the same or in a different embodiment, the method further comprises a step 39 of determining a weather condition and step 23 further comprises configuring the transmitter and/or the receiver in dependence on this weather condition. Steps 37 and 39 may be performed in parallel to step 21 and/or in parallel to each other. Some or all of steps 21, 37 and 39 may be performed in sequence in any desired order.

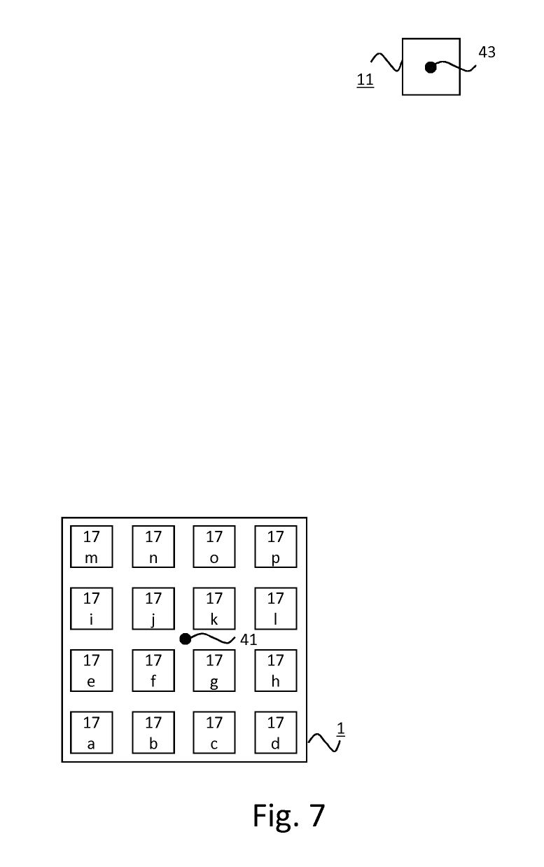

A basic example of how the coefficients of the antenna array 13 may be computed in step 23 is now described with reference to FIG. 7. FIG. 7 shows an environment with a device 1 and a neighboring device 11. In this example, device 1 has an antenna array with sixteen antenna elements 17a-p arranged in a rectangular configuration. The spacing of the antenna elements is d, i.e. the spacing between all horizontally adjacent antenna is d and the spacing between all vertically adjacent antenna elements is also d.

In this example, a depth map is acquired in step 35 and this depth map comprises the coordinates of neighboring device 11. For the purpose of this example, a coordinate system is used where the origin 41 coincides with the location of device 1. The origin 41 is denoted by (0,0) and the location 43 of neighboring device 11 is denoted by (x, y). An extension to three dimensions is straightforward.

When device 1 transmits data to neighboring device 11 using beamforming, it can be assumed that device 1 transmits a sinusoidal signal from each of the elements 17a-p of antenna array 13. In a practical communication system, narrow-band communications, where the modulated carrier signal resembles a sinusoidal signal, may for example be used.

Furthermore, in case multi-carrier techniques such as OFDM are used, each of the modulated carriers may be a sinusoidal signal also. A phase shift is normally configured per antenna element.

Beamforming is used to obtain a maximal transfer from the antenna array 13 of device 1 to neighboring device 11. This can be accomplished by making sure that each of the sinusoidal signals transmitted from the antenna elements 17a-p are in phase at the location of neighboring device 1. Since device 1 knows the coordinates (x,y) of neighboring device 11 from the depth map, it may compute the phase at (x,y) for a sinusoidal signal transmitted from each of the antenna elements.

The elements of a square antenna array, as depicted in FIG. 7, may be indexed by integer coordinates (i,j). For example, antenna elements 17a, 17b, 17c, 17d, 17e, 17f, 17g, 17h, 17i, 17j, 17k, 171, 17m, 17n, 17o and 17p may be indexed by coordinates (0,0), (1,0), (2,0), (3,0), (0,1), (1,1), (2,1), (3,1), (0,2), (1,2), (2,2), (3,2), (0,3), (1,3), (2,3), (3,3), respectively. Both i and j may run from 0 to K−1 where the number of array elements is N=K². Relative to the origin 41 (0,0), defined as the center of the antenna array 13 of device 1, the distance of each of the antenna array elements 17a-p to (x,y) may be expressed as defined in Equation 1:

d(i,j)={square root over ((x−xₐ(i))²+(y−yₐ(j))²)} (Equation 1)

where xₐ(i) and yₐ(j) are the x and y coordinate of array element OA respectively.

In case K is even, xₐ(i) and yₐ(j) may be expressed as defined in Equations 2 and 3:

$$\begin{matrix}{x}_{a} ( i ) = - \frac{dK}{2} + \frac{d}{2} + id & ( Equation 2 ) \\ {y}_{a} ( j ) = - \frac{dk}{2} + \frac{d}{2} + jd & ( Equation 3 )\end{matrix}$$

The shift in phase for a sinusoidal signal transmitted from array element (i,j) at (x,y) may now be expressed as defined in Equation 4:

$$ϕ ( i , j ) = 2 π \frac{d ( i , j )}{λ} \qquad ( Equation 4 )$$

where λ=c/f denotes the wavelength of the sinusoidal wave, c the speed of light, and f the frequency of the sinusoidal wave.

Given these phase shifts, the coefficient w(i,j) for antenna element (i,j) may now be chosen as defined in Equation 5:

w(i,j)=e^{-jφ(i,j)} (Equation 5)

which effectively compensates for the phase shift at the location of neighboring device 11.

Consider another example that differs from the previous example in that device 1 employs a rectangular array with a total number of 64 antennas (K=8) with an antenna spacing of d=0.075 m. Device 1 may use a sinusoidal carrier of 2 GHz, for example. Device 1 may detect that neighboring device 11 is present at coordinates (x,y)=(5,8), and compute a resulting phase shift for each of the 64 array elements.

The phase shift for each of the array elements may be calculated with the following Python script:

import numpy as np
import matplotlib.pyplot as plt
import cmath
import math
def example( ):

| | |
|---|---|
| K = 8 | # Array has 8x8=64 elements |

| | |
|---|---|
| d = 0.075 | # Spacing between array elements |

| | |
|---|---|
| x = 5 | # x coordinate of Device B |
| y = 8 | # y coordinate of Device B |

| | |
|---|---|
| f = 2e9 | # Frequency of sinusoidal |

coef, phase = compute_array_tranfer_coef_efficients(K, d, x, y, f)
# We observe the antenna pattern at a radius of 10m and plot the result
theta, phi_vec = plot_antenna_pattern_square_array(K, d, coef, 10, f)

def plot_antenna_pattern_square_array(K, d, array_coefficients, r, f):

phi_vec = [ ]
theta = np.arange(0, 2*np.pi, 0.01)
array_xi = range(0, K, 1)
array_yi = range(0, K, 1)
for t in theta:

x = math.cos(t)*r
y = math.sin(t)*r
phi_t = 0.0
for i in array_xi:

xa = −d*K/2+d/2 + i*d
for j in array_yi:

ya = −d*K/2+d/2 + j*d
di = math.sqrt(pow(x-xa, 2) + pow(y-ya, 2))
phi = 2*np.pi*di/(3e8/f)
coef = cmath.exp(complex(0, 1)*phi)*array_coefficients[i][j]
phi_t += coef

phi_vec += [abs(phi_t)]

phi_vec = phi_vec/max(phi_vec)
ax = plt.subplot(111, projection=‘polar’)
ax.plot(theta, phi_vec, color=‘k’, linewidth=3)
ax.set_rmax(1.0)
plt.show( )
return theta, phi_vec

def compute_array_tranfer_coef_efficients(K, d, x, y, f):

array_coefficients = np.empty([K, K], dtype=complex)
coefficients_phase = np.empty([K, K], dtype=float)
array_d = np.empty([K])
array_xi = range(0, K, 1)
array_yi = range(0, K, 1)
for i in array_xi:

xa = −d*K/2+d/2 + i*d
for j in array_yi:

ya = −d*K/2+d/2 + j*d
di = math.sqrt(pow(x-xa, 2) + pow(y-ya, 2))
phi = np.pi*2*di/(3e8/f)
array_coefficients[i][j] = cmath.exp(complex(0, 1)*-phi)
coefficients_phase[i][j] = 360*cmath.phase(array_coefficients[i][j])/(2*np.pi)

return array_coefficients, coefficients_phase

The resulting phase for each of the antenna elements calculated with this Python script are shown in the following table:

TABLE 1
Computed phase shifts in degrees for
a rectangular array with 64 elements

| | i = 0 | i = 1 | i = 2 | i = 3 | i = 4 | i = 5 | i = 6 | i = 7 |
|---|---|---|---|---|---|---|---|---|
| j = 7 | −138 | −37 | 62 | 161 | −101 | −4 | 91 | −174 |
| j = 6 | 73 | 173 | −88 | 10 | 107 | −157 | −62 | 32 |
| j = 5 | −77 | 23 | 121 | −141 | −45 | 50 | 145 | −122 |
| j = 4 | 133 | −128 | −30 | 67 | 162 | −103 | −9 | 83 |
| j = 3 | −17 | 81 | 178 | −86 | 9 | 104 | −163 | −72 |
| j = 2 | −168 | −70 | 26 | 122 | −144 | −50 | 42 | 133 |
| j = 1 | 41 | 138 | −126 | −31 | 62 | 155 | −113 | −22 |
| j = 0 | −111 | −14 | 81 | 175 | −92 | 0 | 92 | −178 |

These phases may then be used to set the array coefficients as defined in Equation 6:

w(i,j)=e^{-φ(i,j)} (Equation 6)

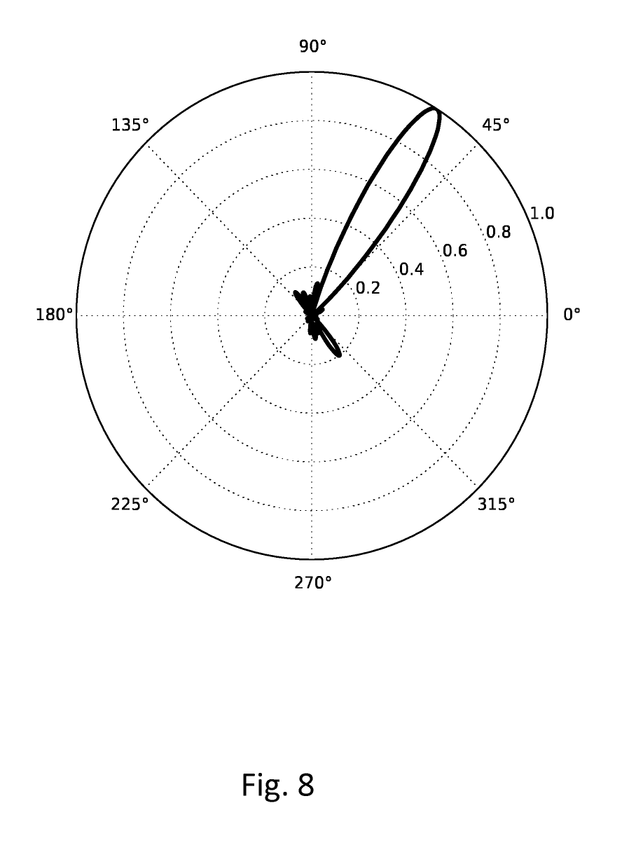

The resulting antenna pattern is shown in FIG. 8. The antenna pattern shows the achieved directionality from device 1 towards the location of neighboring device 11.

The computation of coefficients for receiving data from a neighboring device 11 is similar to the computation of coefficients for transmitting data to the neighboring device 11 described in the previous paragraphs. This is because of the reciprocity of propagation of electromagnetic waves. Hence to achieve a particular directionality for transmission and reception, the same array coefficients may be used. Many other methods exist to compute the array coefficients when for instance noise is taken into account, multiple devices are present, and/or side lobes of the antenna pattern are suppressed.

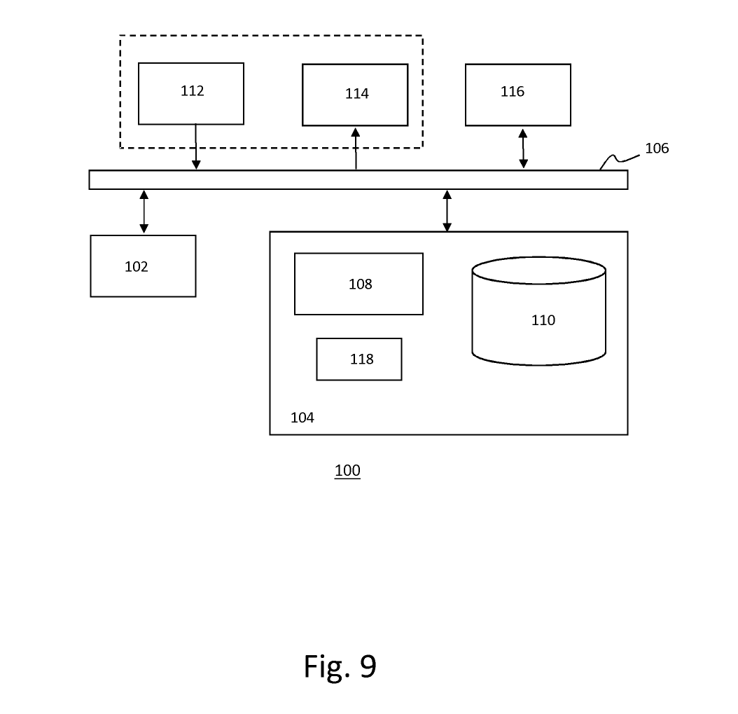

FIG. 9 depicts a block diagram illustrating an exemplary data processing system that may perform the method as described with reference to FIG. 6.

As shown in FIG. 9, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification. The data processing system 100 may further comprise the at least one of a transmitter and a receiver of the device of the invention, for example. Alternatively, the device 1 of FIG. 1 may comprise the data processing system 100 of FIG. 9, for example.

The memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 9 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

As pictured in FIG. 9, the memory elements 104 may store an application 118. In various embodiments, the application 118 may be stored in the local memory 108, the one or more bulk storage devices 110, or separate from the local memory and the bulk storage devices. It should be appreciated that the data processing system 100 may further execute an operating system (not shown in FIG. 9) that can facilitate execution of the application 118. The application 118, being implemented in the form of executable program code, can be executed by the data processing system 100, e.g., by the processor 102. Responsive to executing the application, the data processing system 100 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 102 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A vehicle comprising a device for communicating with at least one neighboring device, the device comprising:
at least one of a transmitter for transmitting a data signal to at least one neighboring device or a receiver for receiving a data signal from at least one neighboring device; and
a processor configured to determine at least one of a distance or a direction to at least one neighboring device relative to the device, the at least one of the distance or the direction being determined using at least one sensor other than the receiver, to configure at least one of the at least one of the transmitter or the receiver in dependence on the at least one of the distance or the direction, and to use the at least one of the transmitter or the receiver, the transmitter being used to transmit a data signal to at least one of the at least one neighboring device and the receiver being used to receive a data signal from at least one of the at least one neighboring device.

2. The vehicle of claim 1, wherein the vehicle is a car.

3. The vehicle of claim 1, wherein the processor is further configured to determine a distance to the at least one neighboring device relative to the device and to configure the transmitter to adapt its power in dependence on the distance to the at least one neighboring device relative to the device.

4. The vehicle of claim 1, wherein the processor is further configured to determine a direction to at least one neighboring device relative to the device and to configure the at least one of the transmitter or the receiver to adapt its directivity in dependence on the direction to the at least one neighboring device relative to the device.

5. The vehicle of claim 1, wherein the device comprises the at least one sensor.

6. The vehicle of claim 1, wherein the at least one sensor uses at least one of LIDAR, radar, sonar, image recognition, structured light or 3D vision to determine the at least one of the distance or the direction to the at least one neighboring device relative to the device.

7. The vehicle of claim 1, wherein the processor is further configured to determine a distance and a direction to the at least one neighboring device relative to the device.

8. The vehicle of claim 7, wherein the processor is further configured to determine a depth map from the distance or the direction to the at least one neighboring device relative to the device.

9. The vehicle of claim 1, wherein the processor is further configured to determine at least one of a movement speed or a movement direction of the at least one neighboring device relative to the device and to configure the at least one of the transmitter or receiver in dependence on the at least one of the movement speed or the movement direction.

10. The vehicle of claim 1, wherein the at least one of the transmitter or the receiver is coupled to an array of antennas.

11. The vehicle of claim 1, wherein the processor (7) is further configured to determine a weather condition and to configure the at least one of the transmitter (3) or the receiver (5) in dependence on the weather condition.

12. A method of communicating with at least one neighboring device, the method comprising:
determining at least one of a distance or a direction to at least one neighboring device relative to a device, wherein the device is comprised in a vehicle, the at least one of the distance or the direction being determined using at least one sensor other than a receiver used by the device to receive a data signal from the at least one neighboring device;
configuring at least one of a transmitter or the receiver in dependence on the at least one of the distance or the direction; and
using the at least one of the transmitter or the receiver, the transmitter being used to transmit a data signal from the device to at least one of the at least one neighboring device and the receiver being used to receive a data signal from at least one of the at least one neighboring device on the device.

13. The method of claim 12, wherein the vehicle is a car.

14. The method of claim 12, wherein the at least one sensor uses at least one of LIDAR, radar, sonar, image recognition, structured light or 3D vision to determine the at least one of the distance or the direction to the at least one neighboring device relative to the device.

15. The method of claim 12, wherein determining at least one of the distance or the direction to at least one neighboring device relative to the device comprises determining the distance or the direction to the at least one neighboring device relative to the device.

16. The method of claim 15, wherein determining (21) at least one of distance or the direction to at least one neighboring device relative to the device comprises determining (35) a depth map from the distance or the direction to the at least one neighboring device relative to the device.

17. A non-transitory computer-readable medium having stored thereon instructions than, when executed by a processor of a vehicle comprising a device, cause the processor to execute instructions including:
determining at least one of a distance or a direction to at least one neighboring device relative to the device, the at least one of the distance or the direction being determined using at least one sensor other than a receiver used by the device to receive a data signal from the at least one neighboring device;
configuring at least one of a transmitter of the device or the receiver in dependence on the at least one of the distance or the direction; and
using the at least one of the transmitter or the receiver, the transmitter being used to transmit a data signal from the device to at least one of the at least one neighboring device and the receiver being used to receive a data signal from at least one of the at least one neighboring device on the device.
